(19) United States
(12) Patent Application Publication
(10) Pub. No.: US 2017/0132701 A1
(43) Pub. Date: May 11, 2017

(54) METHOD FOR MATCHING SUPPLY AND DEMAND FOR TRANSACTIONS BETWEEN MULTIPLE CUSTOMERS AND TRANSACTION MANAGEMENT SYSTEM USING THE SAME MEDIUM

(71) Applicant: INSTITUTE FOR INFORMATION INDUSTRY, TAIPEI CITY (TW)

(72) Inventors: Tien-Kuan Kung, NEW TAIPEI CITY (TW); CHIA-SHIN YEN, Taipei City (TW)

(21) Appl. No.: 14/957,166

(22) Filed: Dec. 2, 2015

(30) Foreign Application Priority Data
Nov. 11, 2015 (TW) 104137188

(51) Int. Cl. G06Q 40/04

(52) U.S. Cl. CPC G06Q 40/04

(57) ABSTRACT

A method for matching supply and demand for transactions between multiple customers and a transaction management system using the same. The method and the transaction management system match supply and demand according to the trading capacity, the time interval and the unit price provided by the buying/selling customers and the risk of power tripping of each of the buying customers so as to achieve a win-win situation for each customer by avoiding the fine for contracted quantity exceeding for the buying customers and avoiding the fee for unused electricity for the selling customers.

### BACKGROUND

1. Technical Field

The present invention generally relates to a method for matching supply and demand for transactions between multiple customers and a transaction management system using the same and, more particularly, to a method and a transaction management system capable of matching supply and demand according to the trading capacity, the time interval and the unit price provided by the buying/selling customers and the risk of power tripping of each of the buying customers.

2. Description of Related Art

The power company contracts with each of the customers for a contract capacity, according to which the power company provides a reserve capacity on a power supply feeder to prevent regional power tripping due to power supply shortage. It should be noted that the power company charges the customers based on the contract capacity even though the customers may not consume electricity up to the contract capacity. On the contrary, the customers have to pay a high fine for contracted quantity exceeding if the customers consume electricity exceeding the contract capacity.

However, the customers on the same power supply feeder have different trading capacities at different unit prices during different time intervals. There is a need to provide a method for matching supply and demand for transactions between multiple customers and a transaction management system using the same.

### SUMMARY

One embodiment of the present invention provides a method for matching supply and demand for transactions between multiple customers with respect to a power supply feeder using a transaction management system. Each of the multiple customers corresponds to a contract capacity and a trading information, and the trading information includes a trading capacity, a time interval and a unit price. The method includes the steps herein. The transaction management system decides a plurality of buying customers and a plurality of selling customers according to a customer baseline and the contract capacity of each of the multiple customers. The transaction management system compares the trading information of each of the plurality of buying customers and the plurality of selling customers, and selects one of the plurality of selling customers as one from a candidate selling customer portfolio corresponding to one of the plurality of buying customers if the unit price of the one of the plurality of selling customers is lower than the unit price of the one of the plurality of buying customers and if the time interval of the one of the plurality of selling customers overlaps with the time interval of the one of the plurality of buying customers. The transaction management system calculates a power tripping possibility of each of the plurality of buying customers and deciding a transaction priority of the one of the plurality of buying customers. The one of the plurality of buying customers with a higher power tripping possibility has a higher transaction priority. The transaction management system matches each of the plurality of buying customers with each from the candidate selling customer portfolio according to the transaction priority of each of the plurality of buying customers.

One embodiment of the present invention further provides a transaction management system for matching supply and demand for transactions between multiple customers with respect to a power supply feeder. Each of the multiple customers corresponds to a contract capacity and a trading information, and the trading information includes a trading capacity, a time interval and a unit price. The transaction management system includes a first decision module, a first determination module, a first operation module and a matching module. The first decision module is configured to decide a plurality of buying customers and a plurality of selling customers according to a customer baseline and the contract capacity of each of the multiple customers. The first determination module is configured to compare the trading information of each of the plurality of buying customers and the plurality of selling customers, and select one of the plurality of selling customers as one from a candidate selling customer portfolio corresponding to one of the plurality of buying customers if the unit price of the one of the plurality of selling customers is lower than the unit price of the one of the plurality of buying customers and if the time interval of the one of the plurality of selling customers overlaps with the time interval of the one of the plurality of buying customers. The first operation module is configured to calculate a power tripping possibility of each of the plurality of buying customers and decide a transaction priority of the one of the plurality of buying customers. The one of the plurality of buying customers with a higher power tripping possibility has a higher transaction priority. The matching module is configured to match each of the plurality of buying customers with each from the candidate selling customer portfolio according to the transaction priority of each of the plurality of buying customers.

As stated above, the method for matching supply and demand for transactions between multiple customers and the transaction management system using the same provided in the present invention are based on the trading capacity, the time interval and the unit price provided by the buying/selling customers and the risk of power tripping of each of the buying customers so as to achieve a win-win situation for each customer by avoiding the fine for contracted quantity exceeding for the buying customers and avoiding the fee for unused electricity for the selling customers. In addition, the method and the transaction management system using the same also prevent regional power tripping due to serious overloading on the power supply feeder in a short period so as to stabilize power supply.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a schematic diagram of multiple customers with respect to a power supply feeder according to one exemplary embodiment of the present invention;

FIG. 2 is a flowchart of a method for matching supply and demand for transactions between multiple customers according to one exemplary embodiment of the present invention;

FIG. 3A is a graph showing the customer baseline of customers A in FIG. 1;

FIG. 3B is a graph showing the customer baseline of customers B in FIG. 1;

FIG. 4 shows the trading information of the multiple customers in FIG. 1;

FIG. 5 is a flowchart of a method for matching each of the buying customers with each from the candidate selling customer portfolio according to one exemplary embodiment of the present invention;

FIG. 6 shows the time intervals of customers A and the candidate selling customer portfolio in FIG. 1;

FIG. 7 shows a matching equation used in the method according to one exemplary embodiment of the present invention;

FIG. 8 shows another trading information of the multiple customers in FIG. 1;

FIG. 9 shows another trading information of the multiple customers in FIG. 1; and

FIG. 10 is a block diagram of a transaction management system for matching supply and demand for transactions between multiple customers according to one exemplary embodiment of the present invention.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

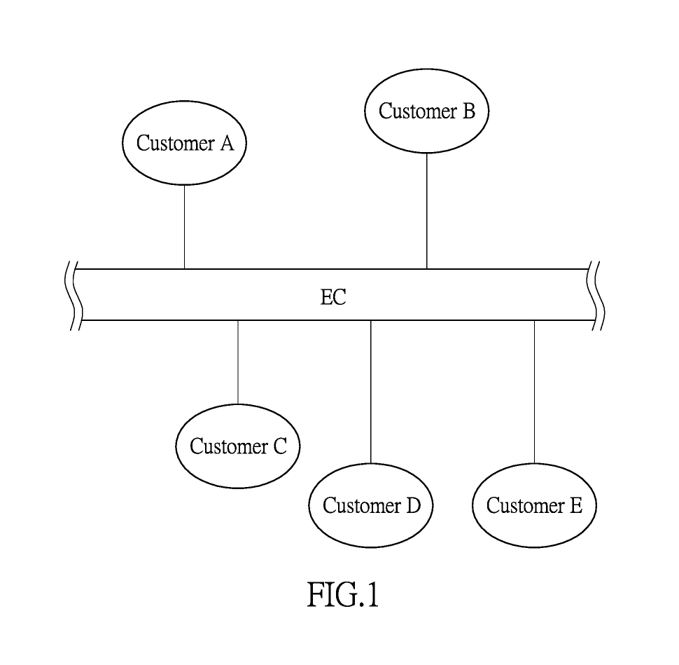

Referring to FIG. 1, FIG. 1 is a schematic diagram of multiple customers with respect to a power supply feeder according to one exemplary embodiment of the present invention. It should be noted that the example in FIG. 1 is only exemplary and the present invention is not limited to the number and arrangement of the customers with respect to the power supply feeder EC in FIG. 1.

For example, customers A-E may deal with the power company for a contract capacity, but customers C-E do not consume electricity up to the contract capacity in each of the time intervals, which causes a waste of electricity supply from the power company and extra fees paid by customers C-E. On the contrary, during a certain time interval, when customer A and customer B consume electricity over the respective contract capacities, customer A and customer B have to pay the power company a high fine and it is very likely to induce the risk of regional power tripping.

Accordingly, if the surplus power capacity that customer C does not consume in a certain time period is released to customer A or customer B, or if the exceeding power capacity that customer A or customer B requires in a certain time period is purchased from customers C-E, the high fine paid by customer A or customer B and the extra fees for the surplus power capacity paid by customers C-E can be avoided to achieve a win-win situation for each of customers. Accordingly, in the present invention, regional power tripping due to serious overloading on the power supply feeder EC in a short period can be avoided so as to maintain the stability of the power supply feeder EC.

However, on the power supply feeder EC, there is more than one buying customer, such as customers A-B, and/or more than one selling customer, such as customers C-E, that needs to participate in transactions. The time intervals for customers A-E to participate in transactions may also vary. It is a crucial topic in power transaction to develop a method for matching supply and demand for transactions between multiple customers.

According to the teachings stated above, a person with ordinary skill in the art should understand that the method for matching supply and demand for transactions between multiple customers according to one embodiment of the present invention uses a transaction management system applicable to multiple customers with respect to a power supply feeder. Each of the multiple customers contracts with the power company for a contract capacity, and each customer corresponds to a trading information. The trading information includes a trading capacity, a time interval and a unit price.

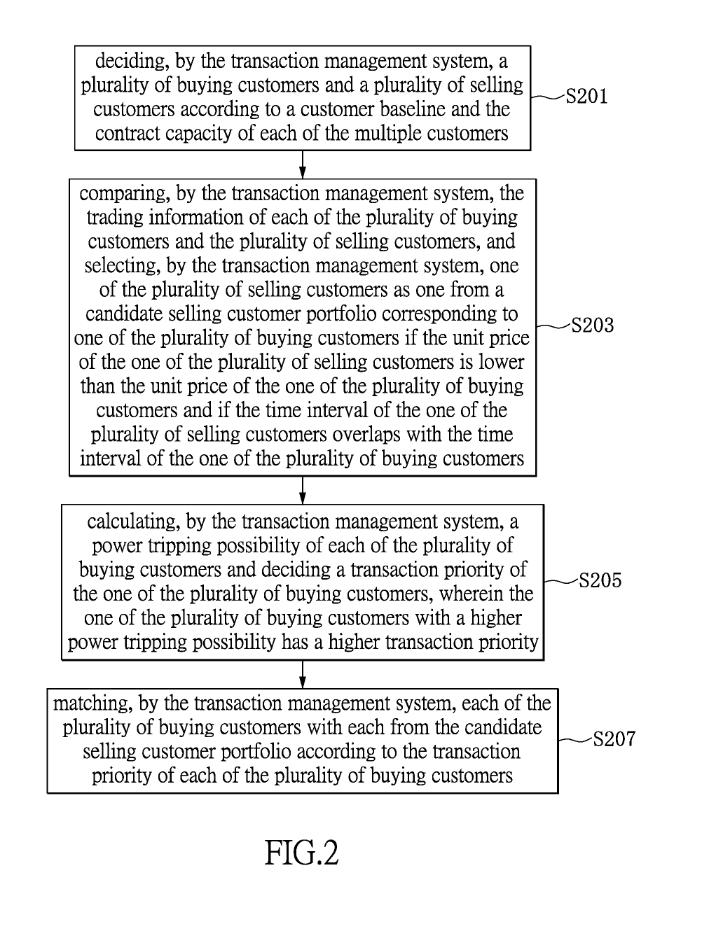

Referring to FIG. 2, FIG. 2 is a flowchart of a method for matching supply and demand for transactions between multiple customers according to one exemplary embodiment of the present invention. First, in Step S201, the transaction management system decides a plurality of buying customers and a plurality of selling customers according to a customer baseline and the contract capacity of each of the multiple customers. Next, in Step S203, the transaction management system compares the trading information of each of the plurality of buying customers and the plurality of selling customers. The transaction management system selects one of the plurality of selling customers as one from a candidate selling customer portfolio corresponding to one of the plurality of buying customers if the unit price of the one of the plurality of selling customers is lower than the unit price of the one of the plurality of buying customers and if the time interval of the one of the plurality of selling customers overlaps with the time interval of the one of the plurality of buying customers.

Then, in Step S205, the transaction management system calculates a power tripping possibility of each of the plurality of buying customers and deciding a transaction priority of the one of the plurality of buying customers. The one of the plurality of buying customers with a higher power tripping possibility has a higher transaction priority. Finally, in Step S207, the transaction management system matches each of the plurality of buying customers with each from the candidate selling customer portfolio according to the transaction priority of each of the plurality of buying customers.

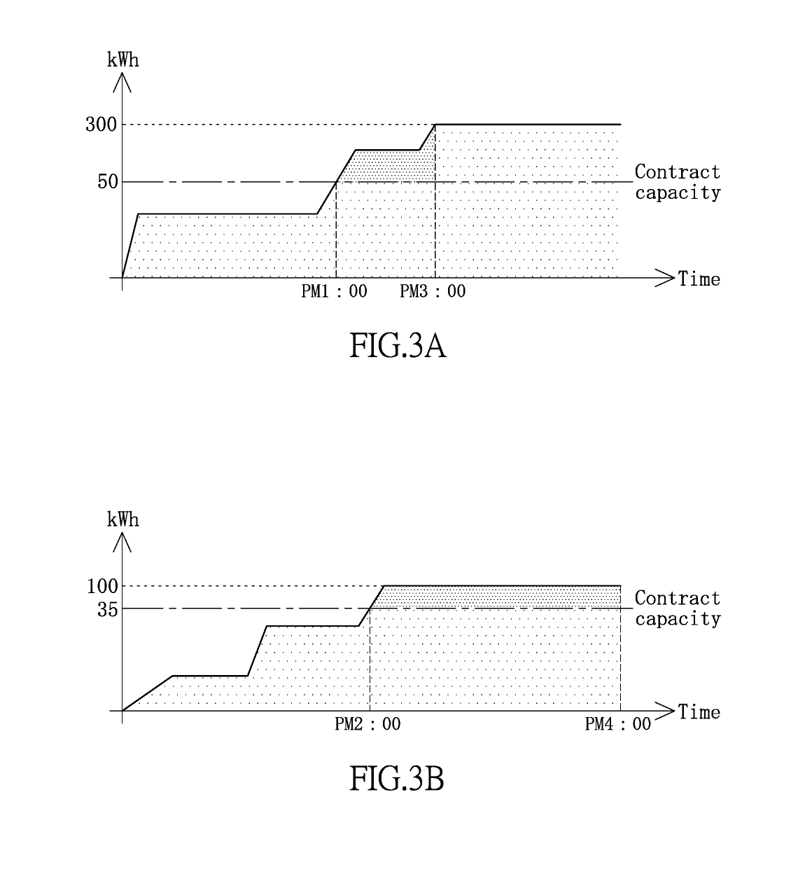

For the sake of convenience, the exemplary embodiment in FIG. 1 is described as an example, to which the present invention is not limited. More particularly, the customer baseline (CBL) is a projected power capacity based on the power consumption history of a customer. Therefore, in Step S201, the transaction management system calculates the customer baseline of each customer. Then, when the transaction management system decides that the customer baselines of customers A-B are higher than their contract respective capacities, customers A-B are defined as buying customers. On the contrary, when the transaction management system decides that the customer baselines of customers C-E are lower than their respective contract capacities, customers C-E are defined as selling customers. The respective customer baselines of customers A-B are as shown as in FIG. 3A and FIG. 3B. The respective customer baselines of customers C-E are not presented herein. It should be noted that the present invention is not limited to the implementations of the respective customer baselines of customers A-E, a person with ordinary skill in the art may make any modifications according to practical demand Moreover, the method for deciding whether a customer is a buying customer or a selling customer by determining whether the respective customer baseline is higher or lower than the contract capacity is only exemplary and is not intended to limit the scope of the present invention.

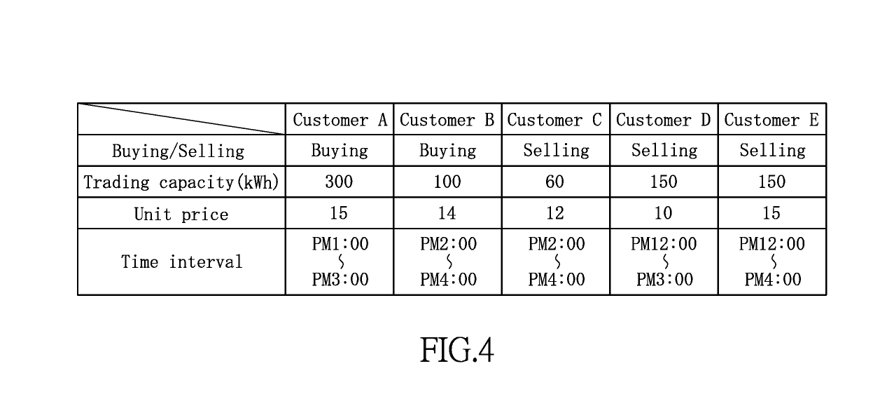

On the other hand, after the transaction management system decides that customers A-E are buying customers or selling customers, in Step S201, the transaction management system initiating the trading information of each of the buying customers (i.e., customers A-B) and the selling customers (i.e., customers C-E). Practically, the initiation uses the transaction management system to allow each of the customers A-E to provide the parameters for transactions. For example, if customer A plans to purchase 300 units of power at a unit price of at least 15 dollars during PM1:00-PM3:00, customer A may provide the trading information as: the trading capacity=300 (kWh), the time interval=PM1:00-PM3:00 and the unit price=15 (dollars). Moreover, if customer C plans to offer 60 units of power at a unit price of at least 12 dollars during PM2:00-PM4:00, customer C may provide the trading information as: the trading capacity=60 (kWh), the time interval=PM2:00-PM4:00 and the unit price=12 (dollars). However, the present invention is not limited thereto. A person with ordinary skill in the art may make any modifications according to practical demand. It should be noted that the trading information provided by each of customers A-E can be summarized in FIG. 4.

Next, in Step S203, the transaction management system compares the trading information of each of the plurality of buying customers (i.e., customers A-B) and the plurality of selling customers (i.e., customers C-E). If the unit price of one of the plurality of selling customers is lower than the unit price of one of the plurality of buying customers and if the time interval of one of the plurality of selling customers overlaps with the time interval of one of the plurality of buying customers, the transaction management system selects one of the plurality of selling customers as one from a candidate selling customer portfolio corresponding to one of the plurality of buying customers. For example, with reference to FIG. 4, since the unit price (12 dollars) of customer C is lower than the unit price (15 dollars) of customer A, and the time interval (PM2:00-PM4:00) of customer C overlaps with the time interval (PM1:00-PM3:00) of customer A, the transaction management system selects customer C as one from the candidate selling customer portfolio corresponding to customer A. Similarly, after performing Step S20, the transaction management system selects customer C, customer D and customer E as ones from the candidate selling customer portfolio corresponding to customer A, and selects customer C and customer D as ones from the candidate selling customer portfolio corresponding to customer B. In brief, the spirit of Step S203 according one exemplary embodiment of the present invention is that the buying customers match with the selling customers with lower unit prices as ones from the candidate selling customer portfolio.

On the other hand, as previously stated, both of customer A and customer B on the power supply feeder EC require purchased power capacity, and the pre-determined time intervals of customer A and customer B partially overlap (for example, PM2:00-PM3:00). It is crucial to develop a method for deciding which buying customer has higher priority for power transaction.

The one of the plurality of buying customers with a higher power tripping possibility has a higher transaction priority. Finally, in Step S207, the transaction management system matches each of the plurality of buying customers with each from the candidate selling customer portfolio according to the transaction priority of each of the plurality of buying customers.

Accordingly, in Step S205 according one exemplary embodiment of the present invention, the transaction management system calculates a power tripping possibility of each of the buying customers (i.e., customers A-B) on the power supply feeder EC and decides a transaction priority of the buying customers according to the power tripping possibility. Furthermore, in Step S205, the power tripping possibility can be calculated by the equation expressed as:

$$OP = ( \frac{{C}_{MAX} - {C}_{TH}}{{C}_{TH}} ) * 100 \% \qquad ( 1 )$$

wherein, OP denotes the power tripping possibility of each buying customer, C_{MAX} denotes the maximum power consumption (kWh) that each buying customer may consume during the time interval, and C_{TH} denotes the contract capacity (kWh) of each buying customer. Therefore, with reference to FIG. 3A and FIG. 3B, the power tripping possibility of customer A and customer B can be simplified, respectively, as:

$$\begin{matrix}OP\_A = ( \frac{{C}_{MAX} \_A - {C}_{TH} \_A}{{C}_{TH} \_A} ) * 100 = ( \frac{300 - 50}{50} ) * 100 \% = 5 \% ; & ( 2 ) \\ OP\_B = ( \frac{{C}_{MAX} \_B - {C}_{TH} \_B}{{C}_{TH} \_B} ) * 100 = ( \frac{100 - 35}{35} ) * 100 \% = 1.857 \% ; & ( 3 )\end{matrix}$$

wherein, OP_A denotes the power tripping possibility of customer A, C_{NOT}_{_}A denotes the maximum power consumption (kWh) that customer A may consume, C_{TH}_{_}A denotes the contract capacity (kWh) of customer A, OP_B denotes the power tripping possibility of customer B, C_{MAX}_{_}B denotes the maximum power consumption (kWh) that customer B may consume, and C_{TH}_{_}B denotes the contract capacity (kWh) of customer B.

Therefore, according to the above teachings, a person with ordinary skill in the art should understand that the buying customers with power tripping possibilities may be more likely to cause regional power tripping on the power supply feeder EC. Therefore, the buying customers with power tripping possibilities should have higher transaction priorities. Accordingly, after performing Step S205, the transaction management system may decide that the transaction priority of customer A has to be higher than the transaction priority of customer B. In brief, the spirit of Step S205 according one exemplary embodiment of the present invention is that the transaction priority of each of the buying customers and the corresponding candidate selling customer portfolio is decided according to the power tripping possibility of each of the buying customers.

As previously stated, in Step S207, the transaction management system matches customer A with the corresponding candidate selling customer portfolio (i.e., customers C-E) and then the transaction management system matches customer B with the corresponding candidate selling customer portfolio (i.e., customers C-D).

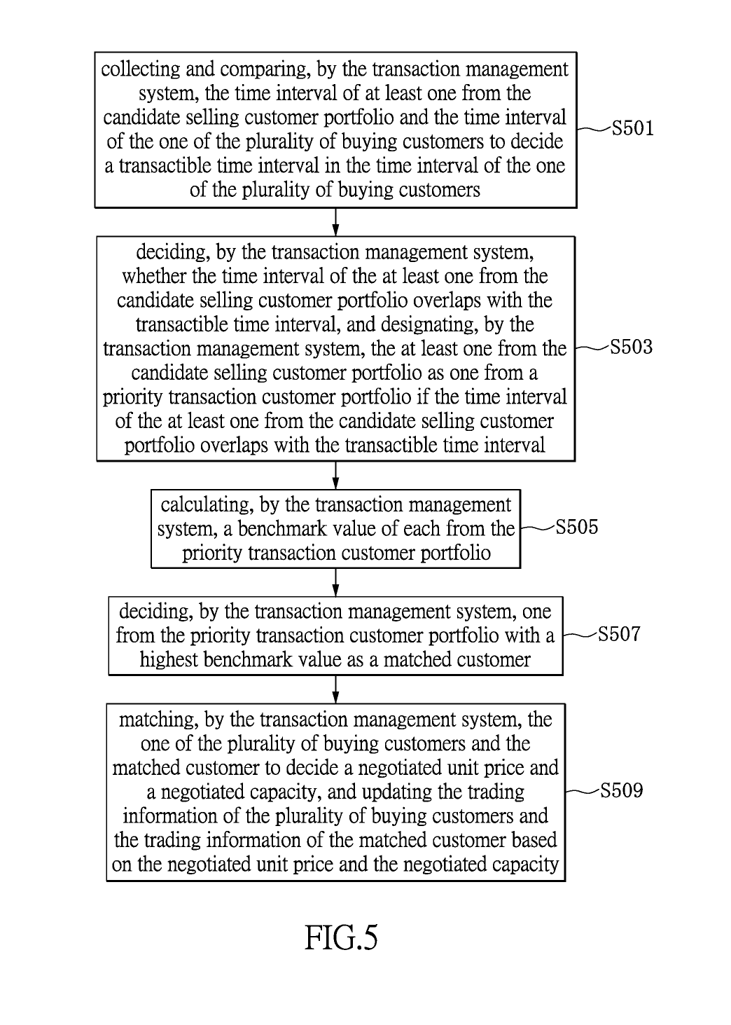

Furthermore, referring to FIG. 5, FIG. 5 is a flowchart of a method for matching each of the buying customers with each from the candidate selling customer portfolio according to one exemplary embodiment of the present invention.

First, in Step S501, the transaction management system collects and compares the time interval of at least one from the candidate selling customer portfolio and the time interval of one of the buying customers to decide a transactible time interval in the time interval of one of the buying customers. Next, in Step S503, the transaction management system decides whether the time interval of each from the candidate selling customer portfolio overlaps with the transactible time interval. If the time interval of one from the candidate selling customer portfolio overlaps with the transactible time interval, the transaction management system designates the one from the candidate selling customer portfolio as one from a priority transaction customer portfolio.

Moreover, in Step S505, the transaction management system calculates a benchmark value of each from the priority transaction customer portfolio. Then, in Step S507, the transaction management system decides one from the priority transaction customer portfolio with a highest benchmark value as a matched customer. Finally, in Step S509, the transaction management system matches the one of the plurality of buying customers and the matched customer to decide a negotiated unit price and a negotiated capacity, and updates the trading information of the plurality of buying customers and the trading information of the matched customer based on the negotiated unit price and the negotiated capacity.

For the sake of convenience, the exemplary embodiment in FIG. 5 is described with customer A and the corresponding candidate selling customer portfolio (i.e., customers C-E) as an example, to which the present invention is not limited.

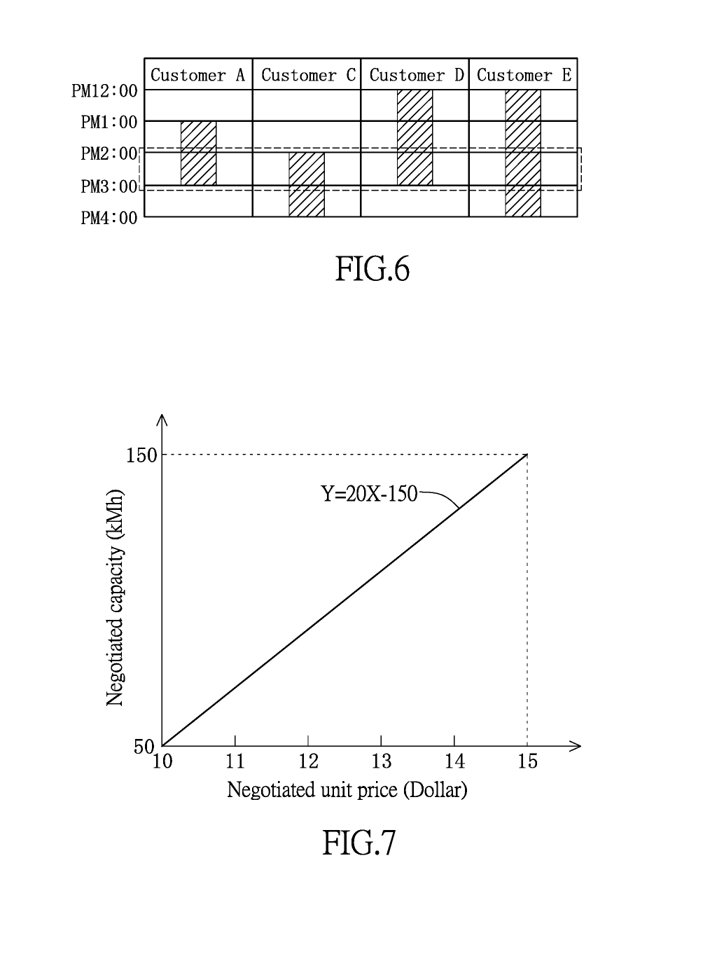

More particularly, referring to FIG. 6, FIG. 6 shows the time intervals of customers A and the candidate selling customer portfolio in FIG. 1. Among the time intervals of customer A and customers C-E, the most overlapped time interval is PM2:00-PM3:00. Therefore, in Step S501, the transaction management system collects and compares the time intervals of customer A and customers C-E to decide a transactible time interval, PM2:00-PM3:00, of customer A. Moreover, in Step S503, since the time intervals of customers C-E also overlap with the transactible time interval PM2:00-PM3:00, each of customers C-E may be selected as one from the priority transaction customer portfolio corresponding to customer A. It should be noted that the most overlapped time interval defined as the transactible time interval is only exemplary and is not intended to limit present invention. In short, a person with ordinary skill in the art may make any modifications according to practical demand.

Then, in Step S505, the transaction management system calculates a benchmark value of each from the priority transaction customer portfolio (i.e., customers C-E). Then, in Step S507, the transaction management system decides one from the priority transaction customer portfolio with a highest benchmark value as a matched customer. More particularly, the benchmark value may be calculated using an equation expressed as C_{BS}/T_{END-START}, wherein C_{BS} denotes the trading capacity of each from the priority transaction customer portfolio, and T_{END-START} denotes a value of the time interval with a unit in hour of each from the priority transaction customer portfolio.

For example, taking the exemplary embodiment in FIG. 4 as an example, the benchmark value of customer C is 60/2=30 (kWh/hr), the benchmark value of customer D is 150/3=50(kWh/hr), and the benchmark value of customer E is 150/4=37.5(kWh/hr). Therefore, in Step S507, it is decided that customer D with the highest benchmark value is selected as the matched customer.

Finally, in Step S509, the transaction management system matches customer A and the matched customer (i.e., customer D) to decide a negotiated unit price and a negotiated capacity, and updates the trading information of customer A and the trading information of the matched customer based on the negotiated unit price and the negotiated capacity. Practically, the transaction management system further determines a matching equation based on the unit price (15 dollars) of customer A and the trading capacity (150 kWh) and the unit price (10 dollars) of the matched customer (i.e., customer D), and matches customer A and customer D according to the matching equation so as to decide the negotiated unit price and the negotiated capacity. It should be noted that the matching equation may be a linear equation or a non-linear equation. However, the present invention is not limited thereto. For example, since customer D plans to offer 150 units of power at a unit price of at least 10 dollars during PM12:00-PM3:00, customer D may sell 50 units of power per hour, leading to 150 units of power in total if the power is sold out. Therefore, when the matching equation is a linear equation, the matching equation can be simplified as shown in FIG. 7.

Accordingly, in Step S509, the transaction management system may keep matching customer A and customer D according to the linear equation (i.e., Y=20X-150) in FIG. 7. For example, customer A and customer D negotiate whether both sides agree to complete the transaction of 70 units of power at the unit price of 11 dollars, or 90 units of power at the unit price of 12 dollars. It should be noted that since customer D does not necessarily agree with customer A to complete the transaction. Therefore, in Step S509, the transaction management system may also check whether the number of times customer A and customer D are being matched has reached a threshold value, such as 8. If the number of times has reached the threshold value, the transaction management system designates the selling customer with the second highest benchmark value as in Step S505 as a new matched customer, and repeats Step S509. Accordingly, this prevents matching failures due to unstoppable matching of non-agreeable customers.

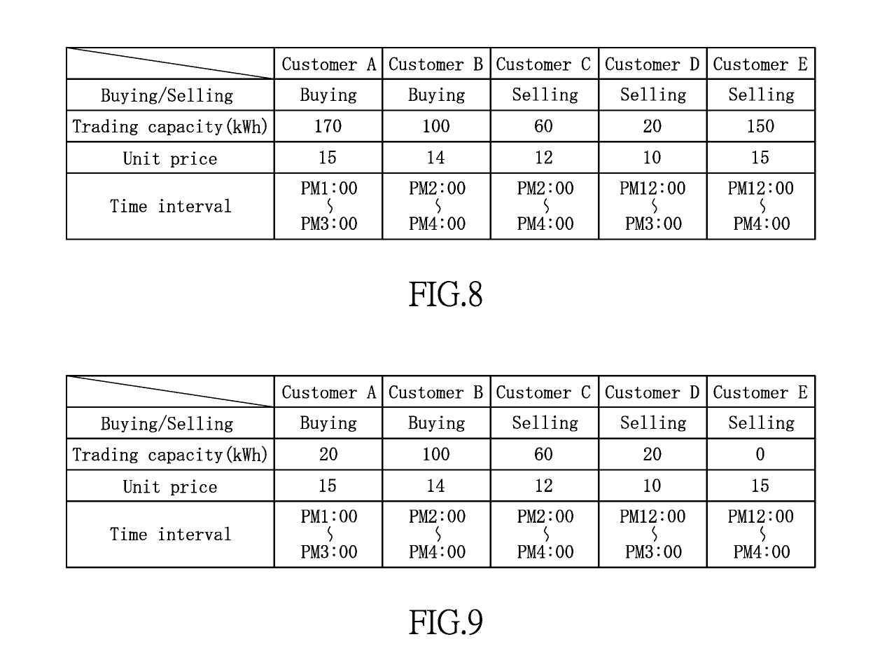

On the other hand, if customer A and customer D finally agree to complete the transaction of 130 units of power at the unit price of 14 dollars, the negotiated unit price in Step S509 is 14 (dollars), and the negotiated capacity is 130 (kWh). The transaction management system further updates the trading information, as shown in FIG. 8, according to the negotiated unit price 14 (dollars) and the negotiated capacity 130 (kWh).

It should be noted that, after performing Step S509, the transaction management system of the present invention further determines whether the trading capacity of the buying customer is zero. If the trading capacity of the buying customer is not zero, the transaction management system repeats Step S501. For example, referring to FIG. 8, customer A purchases 130 units of power from customer D during PM2:00-PM3:00 (i.e., the transactible time interval), and purchases 170 units of power from customer D at the unit price of at least 15 dollars during PM1:00-PM3:00 so as to meet the power requirements. Therefore, in Step S509, when the transaction management system determines that the trading capacity of customer A is not zero, it means that customer A is still in short of power capacity during the time interval. Therefore, customer A has to repeat Step S501 to decide a new transactible time interval so that customer A can purchase enough power as it requires.

It should be noted that, the time interval of the initiated trading information of customer A is PM1:00-PM3:00, however customer A has purchased 130 units of power from customer D during PM2:00-PM3:00. Therefore, when the transaction management system repeats Step S501, the transaction management system may selects the most overlapped time interval of customer A and others from the candidate selling customer portfolio as a new transactible time interval, or a time interval different from the previous transactible time interval as a new transactible time interval. However, the present invention is not limited to how the transactible time interval is decided. A person with ordinary skill in the art may make any modifications according to practical demand.

Furthermore, referring to FIG. 6, if the new transactible time interval is PM1:00-PM2:00, only customers D-E may be selected as one from the priority transaction customer portfolio corresponding to customer A when the transaction management system repeats Step S503. Moreover, referring to FIG. 8, in Step S505, the benchmark value of customer D calculated by the transaction management system is 20/3=6.67(kWh/hr), and the benchmark value of customer E is 150/4=37.5(kWh/hr). Therefore, in Step S507, the transaction management system selects customer E with the highest benchmark value as a new matched customer. Similarly, in Step S509, if customer A and customer E eventually agree to complete the transaction of 150 units of power at the unit price of 15 dollars, the updated trading information in Step S509 is as shown in FIG. 9.

However, since the trading capacity of customer A in FIG. 9 is not zero, the transaction management system repeats Step S501 to decide a new transactible time interval and a new matched customer so that customer A may purchase extra power capacity to meet its power requirement. The detailed descriptions of the follow-up steps are not presented herein. It should be noted that, according to the above teachings, a person with ordinary skill in the art should understand that customers D-E do not have extra power capacity for sale if the new transactible time interval is still PM1:00-PM2:00 and the benchmark value of customers D-E calculated in Step S505 by the transaction management system is zero. Therefore, the transaction management system of the present invention repeats Step S501 to decide a new transactible time interval, such as PM2:00-PM3:00 to select customer C as one from the priority transaction customer portfolio corresponding to customer A so that customer C may meet the requirement of extra power capacity from customer A.

On the other hand, as previously stated, customer C does not necessarily agree to complete transaction with customer A. Therefore, in Step S509, when the number of times the transaction management system matches customer A and customer C has reached the threshold value, such as 8, and there is no more selling customer from the priority transaction customer portfolio can be selected as a new matched customer during the current transactible time interval, the transaction management system repeats Step S501.

Accordingly, in Step S501, the transaction management system determines whether each from the candidate selling customer portfolio (i.e., customers C-E) has been matched with customer A. However, no matter the matching is effective, the transaction management system may repeat Step S207 to match customer B and the candidate selling customer portfolio (i.e. customers C-D) corresponding to customer B for transaction if each from the candidate selling customer portfolio (i.e., customers C-E) has been matched with customer A for transactions. Accordingly, this prevents matching failures due to unstoppable matching of non-agreeable customers.

It should also be noted that, practically, during Step S501 to Step S509, the transaction management system may also check whether a pre-set transaction time period has reached a threshold value such as 30 minutes. If the pre-set transaction time period has reached the threshold value, the matching of customer A and the candidate selling customer portfolio corresponding to customer A is ended and the transaction management system repeats Step S207 to match customer B and the candidate selling customer portfolio (i.e., customers C-D) corresponding to customer B. Accordingly, this prevents matching failures due to unstoppable matching of non-agreeable customers. Moreover, a person with ordinary skill in the art should understand that the threshold value may be a dynamic variable dependent on the number of selling customers in the candidate selling customer portfolio corresponding to each buying customer.

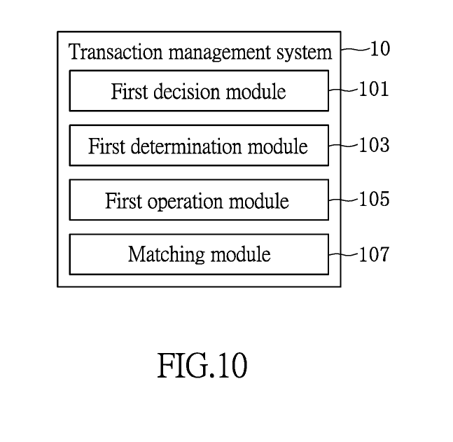

To further describe the transaction management system, the present invention provides a transaction management system according to one exemplary embodiment. Referring to FIG. 10, FIG. 10 is a block diagram of a transaction management system for matching supply and demand for transactions between multiple customers according to one exemplary embodiment of the present invention. However, the transaction management system 10 is only exemplary and is not intended to limit the present invention.

The transaction management system 10 is applicable to multiple customers, such as customers A-E in FIG. 1, with respect to a power supply feeder. Each customer corresponds to a contract capacity and a trading information. The trading information includes a trading capacity, a time interval and a unit price. The transaction management system 10 includes a first decision module 101, a first determination module 103, a first operation module 105 and a matching module 107. More particularly, the transaction management system 10 is capable of performing the steps of the method in FIG. 2. Therefore, please also refer to FIG. 2 for better understanding, and detailed descriptions are not presented herein.

The first decision module 101 is configured to decide a plurality of buying customers and a plurality of selling customers according to a customer baseline and the contract capacity of each of the multiple customers. The first determination module 103 is configured to compare the trading information of each of the plurality of buying customers and the plurality of selling customers, and select one of the plurality of selling customers as one from a candidate selling customer portfolio corresponding to one of the plurality of buying customers if the unit price of the one of the plurality of selling customers is lower than the unit price of the one of the plurality of buying customers and if the time interval of the one of the plurality of selling customers overlaps with the time interval of the one of the plurality of buying customers.

The first operation module 105 is configured to calculate a power tripping possibility of each of the plurality of buying customers and decide a transaction priority of the one of the plurality of buying customers. The one of the plurality of buying customers with a higher power tripping possibility has a higher transaction priority. The matching module 107 is configured to match each of the plurality of buying customers with each from the candidate selling customer portfolio according to the transaction priority of each of the plurality of buying customers.

On the other hand, the matching module 107 according to the present embodiment may also perform the method in FIG. 5 for matching one of the buying customers with one from the candidate selling customer portfolio. Therefore, please also refer to FIG. 5 for better understanding, and detailed descriptions are not presented herein.

As stated above, the method for matching supply and demand for transactions between multiple customers and the transaction management system using the same provided in the present invention are based on the trading capacity, the time interval and the unit price provided by the buying/selling customers and the risk of power tripping of each of the buying customers so as to achieve a win-win situation for each customer by avoiding the fine for contracted quantity exceeding for the buying customers and avoiding the fee for unused electricity for the selling customers. In addition, the method and the transaction management system using the same also prevent regional power tripping due to serious overloading on the power supply feeder in a short period so as to stabilize power supply.

It should also be noted that, compared to the existing matching mechanism, the method and the transaction management system using the same according to the present invention may further enhance the effective matching possibility of the customers and avoid the rick of regional power tripping on the power supply feeder. Therefore, according to the above teachings, a person with ordinary skill in the art should understand that the spirit of the method and the transaction management system using the same of the present invention is on the fitting on the trading capacity, the time interval and the unit price of the customers. Accordingly, the method and the transaction management system using the same of the present invention may also be applicable to the matching of supply and demand of transactions of other energies such as carbon emissions.

The above-mentioned descriptions represent merely the exemplary embodiment of the present disclosure, without any intention to limit the scope of the present disclosure thereto. Various equivalent changes, alterations or modifications based on the claims of present disclosure are all consequently viewed as being embraced by the scope of the present disclosure.

What is claimed is:

1. A method for matching supply and demand for transactions between multiple customers with respect to a power supply feeder using a transaction management system, wherein each of said multiple customers corresponds to a contract capacity and a trading information, and said trading information comprises a trading capacity, a time interval and a unit price, said method comprising steps of:
(A) deciding, by said transaction management system, a plurality of buying customers and a plurality of selling customers according to a customer baseline and said contract capacity of each of said multiple customers;
(B) comparing, by said transaction management system, said trading information of each of said plurality of buying customers and said plurality of selling customers, and selecting, by said transaction management system, one of said plurality of selling customers as one from a candidate selling customer portfolio corresponding to one of said plurality of buying customers if said unit price of said one of said plurality of selling customers is lower than said unit price of said one of said plurality of buying customers and if said time interval of said one of said plurality of selling customers overlaps with said time interval of said one of said plurality of buying customers;
(C) calculating, by said transaction management system, a power tripping possibility of each of said plurality of buying customers and deciding a transaction priority of said one of said plurality of buying customers, wherein said one of said plurality of buying customers with a higher power tripping possibility has a higher transaction priority; and
(D) matching, by said transaction management system, each of said plurality of buying customers with each from said candidate selling customer portfolio according to said transaction priority of each of said plurality of buying customers.

2. The method of claim 1, wherein the step of matching each of said plurality of buying customers with each from said candidate selling customer portfolio comprises steps of:
(El) collecting and comparing, by said transaction management system, said time interval of at least one from said candidate selling customer portfolio and said time interval of said one of said plurality of buying customers to decide a transactible time interval in said time interval of said one of said plurality of buying customers;
(E2) deciding, by said transaction management system, whether said time interval of said at least one from said candidate selling customer portfolio overlaps with said transactible time interval, and designating, by said transaction management system, said at least one from said candidate selling customer portfolio as one from a priority transaction customer portfolio if said time interval of said at least one from said candidate selling customer portfolio overlaps with said transactible time interval;
(E3) calculating, by said transaction management system, a benchmark value of each from said priority transaction customer portfolio;
(E4) deciding, by said transaction management system, one from said priority transaction customer portfolio with a highest benchmark value as a matched customer; and
(E5) matching, by said transaction management system, said one of said plurality of buying customers and said matched customer to decide a negotiated unit price and a negotiated capacity, and updating said trading information of said plurality of buying customers and said trading information of said matched customer based on said negotiated unit price and said negotiated capacity.

3. The method of claim 2, wherein the step (E5) further comprises steps of:
deciding, by said transaction management system, a matching equation based on said unit price of each of said plurality of buying customers and said trading capacity and said unit price of said matched customer; and
matching, by said transaction management system, said plurality of buying customers and said matched customer according to said matching equation to decide said negotiated unit price and said negotiated capacity.

4. The method of claim 2, further comprising, after the step (E5), a step of:
(E6) deciding, by said transaction management system, whether said trading capacity of said plurality of buying customers is zero, wherein said transaction management system repeats step (E1) when said trading capacity of said plurality of buying customers is not zero.

5. The method of claim 2, wherein the step (E3) further comprises steps of:
determining, by said transaction management system, whether said benchmark value of each from said priority transaction customer portfolio is zero, wherein said transaction management system repeats step (E1) when said benchmark value of each from said priority transaction customer portfolio is zero.

6. The method of claim 2, wherein the step (E1) further comprises steps of:
determining, by said transaction management system, whether each from said candidate selling customer portfolio has been matched with said plurality of buying customers, wherein said transaction management system repeats step (D) when each from said candidate selling customer portfolio has been matched with said plurality of buying customers.

7. The method of claim 2, wherein said transaction management system determines whether a pre-set transaction time period reaches a first threshold value, wherein said transaction management system repeats step (D) when said pre-set transaction time period reaches said first threshold value.

8. The method of claim 7, wherein said first threshold value is a dynamic variable dependent on the number of selling customers in said candidate selling customer portfolio.

9. The method of claim 2, wherein said transaction management system determines whether the number of times said plurality of buying customers are matched with said matched customer reaches a second threshold value, wherein said transaction management system designates at least one of said plurality of selling customers from said priority transaction customer portfolio with a second highest benchmark value as said matched customer and repeats step (E5) if the number of times reaches said second threshold value.

10. The method of claim 1, wherein said power tripping possibility with respect to each of said plurality of buying customers is calculated according to a maximum power consumption and said contract capacity of each of said plurality of buying customers.

11. The method of claim 2, wherein said benchmark value of each from said priority transaction customer portfolio is calculated according to said trading capacity and said time interval of each from said priority transaction customer portfolio.

12. The method of claim 1, wherein the step (A) further comprises steps of:
calculating, by said transaction management system, said customer baseline of each of said multiple customers; and
initiating, by said transaction management system, said trading information of each of said plurality of buying customers and said plurality of selling customers.

13. A transaction management system for matching supply and demand for transactions between multiple customers with respect to a power supply feeder, wherein each of said multiple customers corresponds to a contract capacity and a trading information, and said trading information comprises a trading capacity, a time interval and a unit price, said transaction management system comprising:
a first decision module configured to decide a plurality of buying customers and a plurality of selling customers according to a customer baseline and said contract capacity of each of said multiple customers;
a first determination module configured to compare said trading information of each of said plurality of buying customers and said plurality of selling customers, and select one of said plurality of selling customers as one from a candidate selling customer portfolio corresponding to one of said plurality of buying customers if said unit price of said one of said plurality of selling customers is lower than said unit price of said one of said plurality of buying customers and if said time interval of said one of said plurality of selling customers overlaps with said time interval of said one of said plurality of buying customers;
a first operation module configured to calculate a power tripping possibility of each of said plurality of buying customers and decide a transaction priority of said one of said plurality of buying customers, wherein said one of said plurality of buying customers with a higher power tripping possibility has a higher transaction priority; and
a matching module configured to match each of said plurality of buying customers with each from said candidate selling customer portfolio according to said transaction priority of each of said plurality of buying customers.

14. The transaction management system of claim 13, wherein said matching module matches said one of said plurality of buying customers and said candidate selling customer portfolio by performing steps of:
collecting and comparing said time interval of at least one from said candidate selling customer portfolio and said time interval of said one of said plurality of buying customers to decide a transactible time interval in said time interval of said one of said plurality of buying customers;
deciding whether said time interval of said at least one from said candidate selling customer portfolio overlaps with said transactible time interval, and designating said at least one from said candidate selling customer portfolio as one from a priority transaction customer portfolio if said time interval of said at least one from said candidate selling customer portfolio overlaps with said transactible time interval;
calculating a benchmark value of each from said priority transaction customer portfolio;
deciding one from said priority transaction customer portfolio with a highest benchmark value as a matched customer; and
matching said one of said plurality of buying customers and said matched customer to decide a negotiated unit price and a negotiated capacity, and updating said trading information of said plurality of buying customers and said trading information of said matched customer based on said negotiated unit price and said negotiated capacity.
